(19) United States
(12) Patent Application Publication
(10) Pub. No.: US 2021/0064819 A1
(43) Pub. Date: Mar. 4, 2021

(54) SERVER

(71) Applicant: LG ELECTRONICS INC., Seoul (KR)

(72) Inventors: Youngsik KIM, Seoul (KR); Youngwook KIM, Seoul (KR); Hangyeol SUN, Seoul (KR); Dongho KIM, Seoul (KR); Yonghoon KWAK, Seoul (KR)

(73) Assignee: LG ELECTRONICS INC., Seoul (KR)

(21) Appl. No.: 17/006,582

(22) Filed: Aug. 28, 2020

(30) Foreign Application Priority Data
Aug. 29, 2019 (KR) 10-2019-0106852

(51) Int. Cl. G06F 40/216; H04L 12/26

(52) U.S. Cl. CPC G06F 40/216; H04L 43/50

(57) ABSTRACT

The present disclosure relates to a server. The server includes a communicator to receive and transmit data from and to an external network, and a processor to detect and monitor an online issue in the external network through the communicator, wherein the processor collects text from a plurality of external servers, performs learning on the collected text, performs an issue detection, and monitors text corresponding to a confirmed issue. Accordingly, an online issue in a network is effectively detected and monitored.

### CROSS-REFERENCE TO THE RELATED APPLICATION

This application claims priority from Korean Patent Application No. 10-2019-0106852, filed on Aug. 29, 2019, in the Korean Intellectual Property Office, the disclosure of which is incorporated herein by reference in its entirety.

### BACKGROUND OF THE DISCLOSURE

### 1. Field of the Disclosure

The present disclosure relates to a server, and more particularly to a server for effectively detecting and monitoring an online issue in a network.

### 2. Description of the Related Art

An online space produces a large amount of formal or informal data, and the spread of negative online issues that influence businesses and services need to be monitored and analyzed. However, it is difficult to manually check numerous negative issues that occur every day.

Accordingly, there is a need for effective big-data processing architecture for processing a large number of posts to screen for negative issues, and there is a need to configure a basis for rational determination for monitoring whether a negative issue has arisen.

### SUMMARY OF THE DISCLOSURE

An objective of the present disclosure is to provide a server for effectively detecting and monitoring an online issue in a network.

Another objective of the present disclosure is to provide a server for effectively detecting and scoring an online issue in a network.

In accordance with the present disclosure, the above and other objects can be accomplished by the provision of a server including a communicator to receive and transmit data from and to an external network, and a processor to detect and monitor an online issue in the external network through the communicator, wherein the processor collects text from a plurality of external servers, performs learning on the collected text, performs an issue detection, and monitors text corresponding to a confirmed issue.

The processor may perform issue scoring for calculating an issue score of the confirmed issue.

The processor may collect text from the plurality of external servers during a first set period.

The processor may collect text corresponding to a set related word from the plurality of external servers during a first set period.

The processor may perform learning on text corresponding to the confirmed issue.

The processor may perform learning and primary filtering on the collected text through a plurality of issue detection models and may perform secondary filtering thereon through a garbage-filtering model.

The processor may classify the collected text into formal text and informal text through a plurality of issue detection models and may perform formal-text-based learning and informal-text-based learning.

The processor may collect text related to the confirmed issue and may monitor text corresponding to the confirmed issue.

The processor may perform issue scoring in proportion to at least one of a number of text entries corresponding to the confirmed issue, a speed at which text is added, view counts of the text, recommendation of the text, or upvoting of the text during issue scoring.

The processor may provide an issue confirmed through monitoring and a score of the issue therewith.

The processor may include a data collector configured to collect text from a plurality of external servers, a formal issue detector configured to perform learning on the collected text and to detect a formal issue, an informal issue detector configured to perform learning on the collected text and to detect an informal issue, and a monitoring device configured to monitor text corresponding to the confirmed issue.

The monitoring device may include a scorer configured to perform issue scoring for calculating an issue score on the confirmed issue.

The processor may further include a garbage filter configured to perform secondary filtering on results from the formal issue detector and the informal issue detector through a garbage-filtering model.

In accordance with another aspect of the present disclosure, a server includes a communicator to receive and transmit data from and to an external network, and a processor to detect and monitor an online issue in the external network through the communicator, wherein the processor collects text from a plurality of external servers, and performs issue scoring for calculating an issue score of a confirmed issue based on the collected text.

The processor may perform issue scoring in proportion to at least one of a number of text entries corresponding to the confirmed issue, a speed at which text is added, view counts of the text, recommendation of the text, or upvoting of the text during issue scoring.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing an online issue detection system according to an embodiment of the present disclosure;

FIG. 2 is a schematic block diagram showing an internal part of the server illustrated in FIG. 1;

FIG. 3 is a diagram showing an example of a deep neural network (DNN);

FIG. 4 is a block diagram showing an example of an internal part of the processor illustrated in FIG. 2; and

FIGS. 5 to 9 are diagrams for explaining an operation of the processor illustrated in FIG. 4.

### DETAILED DESCRIPTION OF THE PREFERRED EMBODIMENTS

Reference will now be made in detail to the exemplary embodiments of the present disclosure, examples of which are illustrated in the accompanying drawings.

The suffixes “module” and “unit” of elements herein are used for convenience of description and thus can be used interchangeably and do not have any distinguishable meanings or functions.

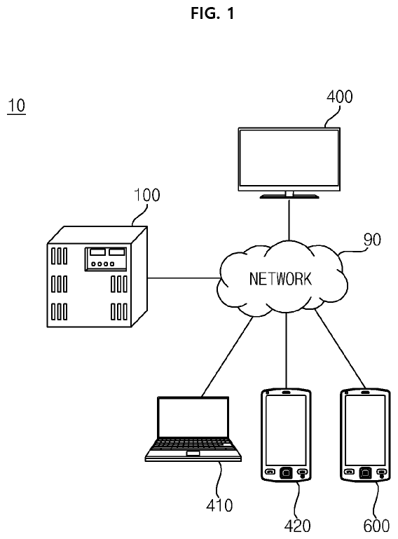

FIG. 1 is a diagram showing an online issue detection system according to an embodiment of the present disclosure.

Referring to the drawing, an online issue detection system 10 of FIG. 1 may include an image display device 400 that accesses a network 90, a computer 410, a tablet 420, a mobile terminal 600, a server 100 for effectively detecting and monitoring an online issue, and a plurality of external servers (not shown).

The server 100 shown in the drawing may be an example of a device for detecting and monitoring an online issue. Differently from the drawing, a function of detecting and monitoring an online issue may be installed in various electronic devices (e.g., an image display device, a computer, or a mobile terminal) in addition to the server 100.

The server 100 may be connected to any one of a plurality of external servers (not shown) through the image display device 400, the computer 410, the tablet 420, the mobile terminal 600, or the like and may receive data related to news provided by a corresponding one of the plurality of external servers.

The server 100 may be connected to any one of a plurality of external servers (not shown) through the image display device 400, the computer 410, the tablet 420, the mobile terminal 600, or the like and may transmit text data through an online bulletin board or the like. That is, the server 100 may transmit community posts, comments, or the like.

An online space using the network 90 may produces a large amount of formal or informal data, and the spread of negative online issues that influence businesses and services needs to be monitored and analyzed.

Thus, the server 100 according to an embodiment of the present disclosure may effectively detect and monitor a relevant issue among numerous issues that occur every day.

To this end, the server 100 according to an embodiment of the present disclosure may access a plurality of external servers, may collect text from the plurality of external servers, may perform learning on the collected text, may detect an issue, and may monitor text corresponding to the confirmed issue. Thus, an online issue in a network may be effectively detected and monitored.

The server 100 according to an embodiment of the present disclosure may perform issue scoring for calculating an issue score on the confirmed issue. An online issue in a network may be effectively detected and scored.

The server 100 according to an embodiment of the present disclosure may collect text from a plurality of external servers during a first set period. Accordingly, text in a network may be effectively collected.

The server 100 according to an embodiment of the present disclosure may collect text from a plurality of external servers corresponding to a set related word during the first set period. Thus, text may be collected from the plurality of external servers corresponding to the set related word. Accordingly, text in a network may be effectively collected.

The server 100 according to an embodiment of the present disclosure may learn text corresponding to the confirmed issue. Accordingly, an online issue in a network may be effectively detected and monitored.

The server 100 according to an embodiment of the present disclosure may perform learning and primary filtering on the collected text through a plurality of issue detection models and may perform secondary filtering on the collected text through a garbage-filtering model. Accordingly, an online issue in a network may be effectively detected and confirmed.

The server 100 according to an embodiment of the present disclosure may classify the collected text into formal text and informal text and may perform formal-text-based learning and informal-text-based learning on the collected text through a plurality of issue detection modules. Thus, an online issue in a network may be effectively detected and confirmed.

The server 100 according to an embodiment of the present disclosure may collect text related to the confirmed issue and may monitor the collected text that corresponds to the confirmed issue. Accordingly, an online issue in a network may be effectively detected and monitored.

The server 100 according to an embodiment of the present disclosure may perform issue scoring in proportion to at least one of the amount of text corresponding to the confirmed issue, the speed at which the text is added, view counts of the text, recommendation of the text, or upvoting of the text during issue scoring. Accordingly, an online issue in a network may be effectively detected and monitored.

The server 100 according to an embodiment of the present disclosure may provide an issue confirmed through monitoring and an issue score therewith. Accordingly, issue-related information may be simply recognized.

The server 100 according to another embodiment of the present disclosure may collect text from a plurality of external servers and may perform issue scoring for calculating the issue score on the confirmed issue based on the collected text. Thus, an online issue in a network may be effectively detected and scored.

The image display device 400 may be a television (TV), a monitor, a display device for a vehicle, or the like.

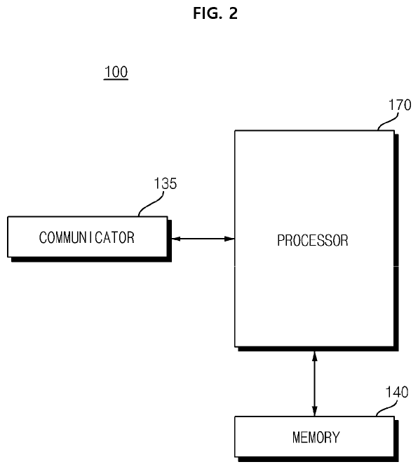

FIG. 2 is a schematic block diagram showing an internal part of the server illustrated in FIG. 1.

Referring to the drawing, the server 100 may include a communicator 135, a processor 170, and a memory 140.

The communicator 135 may receive and transmit data from and to the external network 90.

For example, the communicator 135 may receive text such as news, community posts, or comments from a plurality of servers outside the communicator 135.

The memory 140 may store data required for an operation of the server 100.

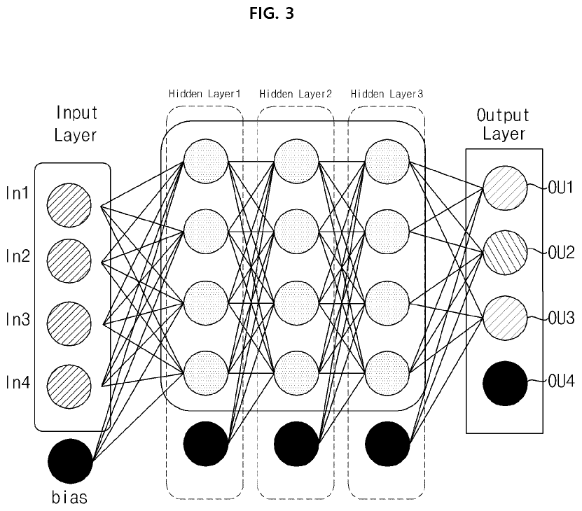

For example, the memory 140 may store an algorithm of learning to be performed by the server 100. In this case, the learning algorithm may be the deep neural network (DNN)-based learning algorithm shown in FIG. 3.

The processor 170 may control the overall operation of the server 100.

The processor 170 may collect text from a plurality of external servers, may perform learning on the collected text, may detect an issue, and may monitor text corresponding to the confirmed issue. Accordingly, an online issue in a network may be effectively detected and monitored.

The processor 170 may perform issue scoring for calculating an issue score on the confirmed issue. An online issue in a network may be effectively detected and scored.

The processor 170 may collect text from a plurality of external servers during the first set period. Accordingly, text in a network may be effectively collected.

The processor 170 may collect text from a plurality of external servers corresponding to a set related word during the first set period. Accordingly, text in a network may be effectively collected.

The processor 170 may perform learning on text corresponding to the confirmed issue. Accordingly, an online issue in a network may be effectively detected and monitored.

The processor 170 may perform learning and primary filtering on the collected text through a plurality of issue detection models, and may perform secondary filtering on the collected text through a garbage-filtering model. Accordingly, an online issue in a network may be effectively detected and confirmed.

The processor 170 may classify the collected text into formal text and informal text and may perform formal-text-based learning and informal-text-based learning on the collected text through a plurality of issue detection modules. Thus, an online issue in a network may be effectively detected and confirmed.

The processor 170 may collect text related to the confirmed issue and may monitor the collected text that corresponds to the confirmed issue. Accordingly, an online issue in a network may be effectively detected and monitored.

The processor 170 may perform issue scoring in proportion to at least one of the amount of text corresponding to the confirmed issue, the speed at which the text is added, view counts of the text, recommendation of the text, or upvoting of the text during issue scoring. Accordingly, an online issue in a network may be effectively detected and monitored.

The processor 170 may provide an issue confirmed through monitoring and an issue score therewith. Accordingly, issue-related information may be simply recognized.

FIG. 3 is a diagram showing an example of a deep neural network (DNN).

Referring to the drawing, the processor 170 may perform learning at a multiphase level that descends to a deep level based on data using deep-learning technology, which is a type of machine learning.

Deep learning may indicate a set of machine-learning algorithms for extracting core data from a plurality of pieces of data through hidden layers.

A deep-learning structure may include a deep neural network (DNN) such as an artificial neural network (ANN), a convolutional neural network (CNN), a recurrent neural network (RNN), or a deep belief network (DBN).

The deep neural network (DNN) may include an input layer, a hidden layer, and an output layer.

The case corresponding to multiple hidden layers may be referred to as a deep neural network (DNN).

Each layer may include a plurality of nodes and may be associated with the next layer. The nodes may have respective weights, and may be connected to each other.

Output from an arbitrary node belonging to a first hidden layer Hidden Layer 1 may be input of at least one node belonging to a second hidden layer Hidden Layer 2. In this case, input of each node may be a value obtained by applying a weight to output of a node of a previous layer. The weight may refer to a connection strength between nodes. A deep-learning procedure may also be considered as a procedure of obtaining an appropriate weight.

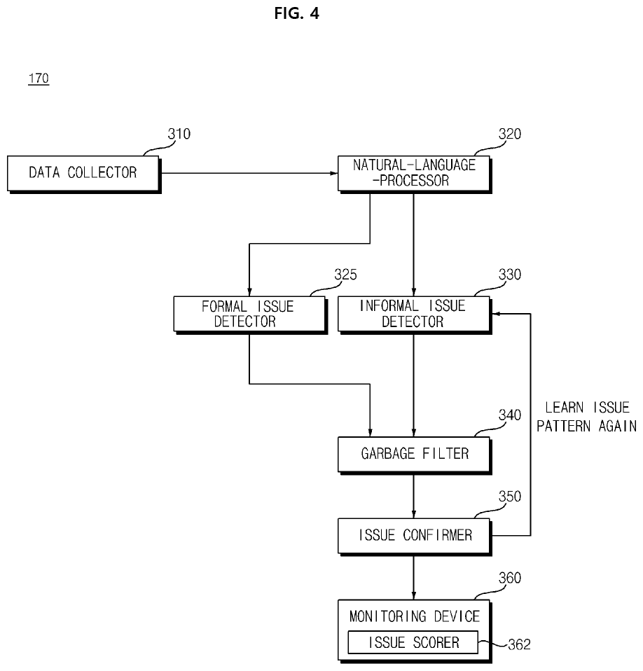

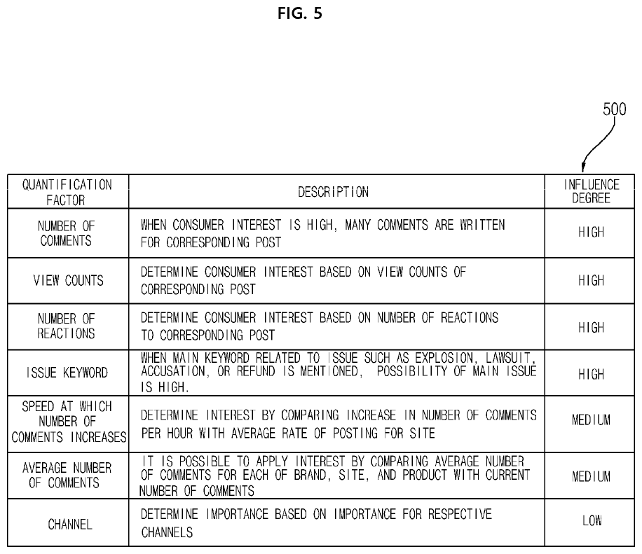

FIG. 4 is a block diagram showing an example of an internal part of the processor illustrated in FIG. 2. FIGS. 5 to 9 are diagrams for explaining an operation of the processor illustrated in FIG. 4.

First, referring to FIG. 4, the processor 170 of FIG. 2 may include a data collector 310, a natural-language-processor 320, a formal issue detector 325, an informal issue detector 330, a garbage filter 340, an issue confirmer 350, and a monitoring device 360.

The data collector 310 may collect text from a plurality of external servers. For example, the data collector 310 may collect news, community posts, comments, or the like from the plurality of external servers.

When it is possible to collect text, the data collector 310 may receive text data related to news, community posts, comments, or the like from a plurality of external servers.

When it is possible to collect text, the data collector 310 may receive image data related to news, community posts, comments, or the like from a plurality of external servers, and may convert the image data into text. In addition, the data collector 310 may acquire the converted text data.

When the issue confirmer 350 confirms an issue, the data collector 310 may access an external server or the like again and may collect only data related to the confirmed issue.

For example, when the confirmed issue is “LG phone”, the data collector 310 may access an external server or the like and may receive text data or image data related to “LG phone”.

The data collector 310 may collect text from a plurality of external servers during a first set period.

The data collector 310 may collect text from a plurality of external servers corresponding to a set related word during the first set period.

The data collector 310 may collect text corresponding to the set related word from a plurality of external servers in a specific area during the first set period.

The data collector 310 may collect all of positive and negative text.

The natural-language-processor 320 may perform natural-language processing on the text data collected from the data collector 310.

The natural-language-processor 320 may perform natural-language processing on the image data collected by the data collector 310 and may extract a natural-language-based text.

The processor 170 may perform learning and primary filtering on the collected text through a plurality of issue detection models and may perform secondary filtering on the collected text through a garbage-filtering model. Accordingly, an online issue in a network may be effectively detected and confirmed.

Here, the plurality of issue detection models may be classified into a formal issue detection model, an informal issue detection model, and the like.

The formal issue detector 325 may perform learning on the collected text and may detect formal issues.

To this end, the formal issue detector 325 may include a formal issue detection model.

Here, the formal sentence may correspond to text data from a media server, provided by a media provider, such as news among news, community posts, and comments.

The formal issue detector 325 may perform learning on the text data from a media server provided by a media provider, such as news, and may detect formal issues.

For example, while learning a plurality of types of text data, the formal issue detector 325 may detect a formal issue with reference to view counts, the number of comments, a share number, or the like, among the plurality of types of text data (e.g., a news article).

The informal issue detector 330 may perform learning on the collected text and may detect informal issues.

To this end, the informal issue detector 330 may include an informal issue detection model.

Here, an informal sentence may correspond to text data that is written by a personal user but not a media provider and is transmitted to a server, such as a community post or a comment among news, community posts, or comments.

The informal issue detector 330 may learn text data recorded in a community server or the like and may detect an informal issue.

For example, while learning a plurality of types of text data, the informal issue detector 330 may detect an informal issue with reference to view counts, the number of comments, a share number, or the like, among the plurality of types of text data (e.g., a post).

The garbage filter 340 may perform secondary filtering through a garbage-filtering model.

For example, the garbage filter 340 may perform secondary filtering on at least one formal issue detected by the formal issue detector 325 through a garbage-filtering model and may filter formal issue content that is inaccurate or similar to an advertising text.

In another example, the garbage filter 340 may perform secondary filtering on at least one informal issue detected by the informal issue detector 330 through a garbage-filtering model and may filter inaccurate informal issue contents, informal issue contents similar to advertising text, profanities, or the like.

The issue confirmer 350 may perform tertiary filtering on text data that is collected the highest number of times during a set searching period among the formal issues and the informal issues that are filtered by the garbage filter 340 and may confirm an issue.

The issue confirmer 350 may confirm that text data that is the most similar to a set search word, among the formal issue and the informal issue filtered by the garbage filter 340, corresponds to an issue.

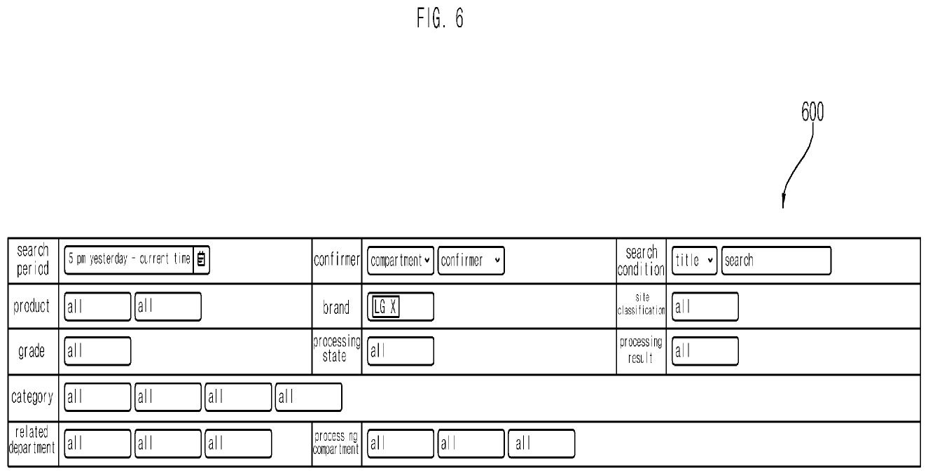

FIG. 6 is a diagram showing a search condition in the form of a set search period from 5 PM on the previous day until the current time.

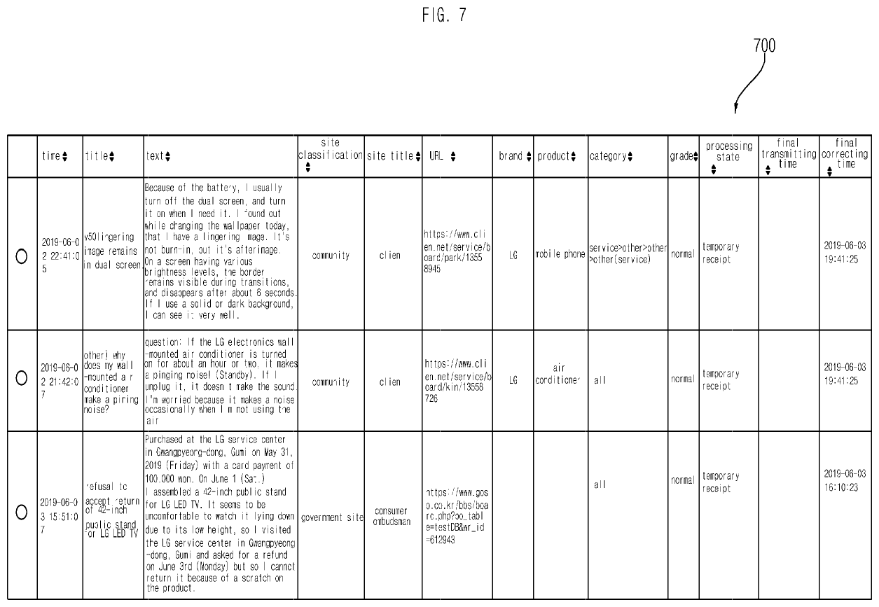

FIG. 7 is a diagram showing a plurality of issues that are confirmed based on the search condition of FIG. 6.

When only the search period is input, as shown in FIG. 6, the issue confirmer 350 may confirm a formal issue, an informal issue, or the like.

As the confirmed issue, FIG. 7 exemplifies a first issue related to ‘LG phone’, a second issue related to ‘LG air conditioner’, and a third issue related to ‘LG TV’.

In FIG. 7, the confirmed issue is not related to media, and thus may correspond to an informal issue.

The monitoring device 360 may collect and monitor text pertaining to the issue confirmed by the issue confirmer 350.

In this case, the monitoring device 360 may collect text pertaining to the confirmed issue through the data collector 310.

Differently from text of an issue prior to confirmation, text pertaining to the confirmed issue may further include a comment and reaction data in addition to a post.

With regard to the first issue related to ‘LG phone’, the second issue related to ‘LG air conditioner’, and the third issue related to ‘LG TV’ which are exemplified in FIG. 7, the monitoring device 360 may monitor a related server, a title of a post, a time at which a post is posted, a URL, a comment, an evaluation, a share level, or the like.

Referring to FIG. 6, three confirmed issues shown in FIG. 7 may correspond to issues during a set period.

In contrast, the confirmed issues shown in FIG. 7 may also be confirmed issues corresponding to the case in which a search word is ‘LG’ during a set period, referring to FIG. 6.

The monitoring device 360 may perform issue scoring based on the collected data, in particular, the collected comment, reaction data, or the like.

To this end, the monitoring device 360 may include an issue scorer 362 for performing calculation of an issue score on a confirmed issue. Thus, an online issue in a network may be effectively detected and scored.

The issue scorer 362 may perform issue scoring in proportion to at least one of the amount of text corresponding to the confirmed issue, the speed at which the text is added, view counts of the text, recommendation of the text, or upvoting of the text during issue scoring. Accordingly, an online issue in a network may be effectively detected and monitored.

The issue scorer 362 may perform issue scoring in inverse proportion to at least one of non-recommendation or downvoting of text that corresponds to the confirmed issue during issue scoring.

As shown in FIG. 5, the issue scorer 362 may assign weights to the number of comments, the number of reactions, issue keywords, the speed at which the number of comments increases, the average number of comments, and channels, and may perform scoring based on the assigned weights.

FIG. 5 shows an example in which a first weight is assigned to the number of comments, the number of reactions, and issue keywords, a second weight that is lower than the first weight is assigned to the speed at which the number of comments increases and the average number of comments, and a third weight, which is lower than the second weight, is assigned to the channels or the like.

Differently from FIG. 5, weights may be assigned to the number of comments, issue keywords, the increase in the number of comments, the number of upvotes, the number of recommendations, the average number of comments, a media channel, and the like, and it may also be possible to perform scoring based on the assigned weights.

In this case, the highest weight may be assigned to the number of comments, the next highest weight may be assigned to the issue keywords, the next highest weight may be assigned to the increase in the number of comments and the number of upvotes, and the lowest weight may be assigned to a media channel.

A scoring factor, etc. shown in FIG. 5 may also be changed via learning.

That is, the issue scorer 362 may change a factor for scoring via learning and may also change a weight assigned to the scoring factor.

The monitoring device 360 may provide an issue confirmed through monitoring and an issue score therewith.

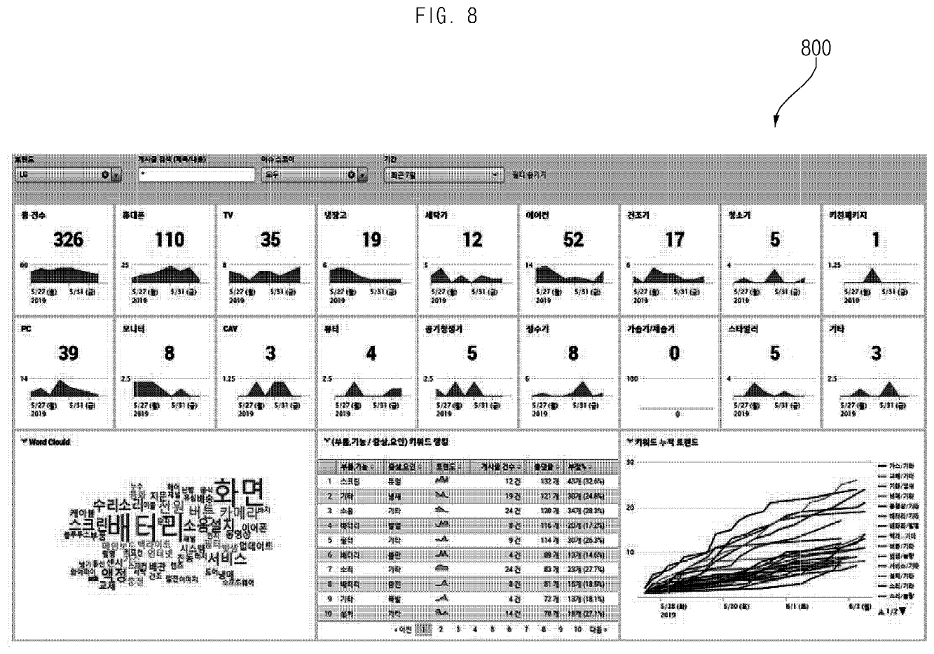

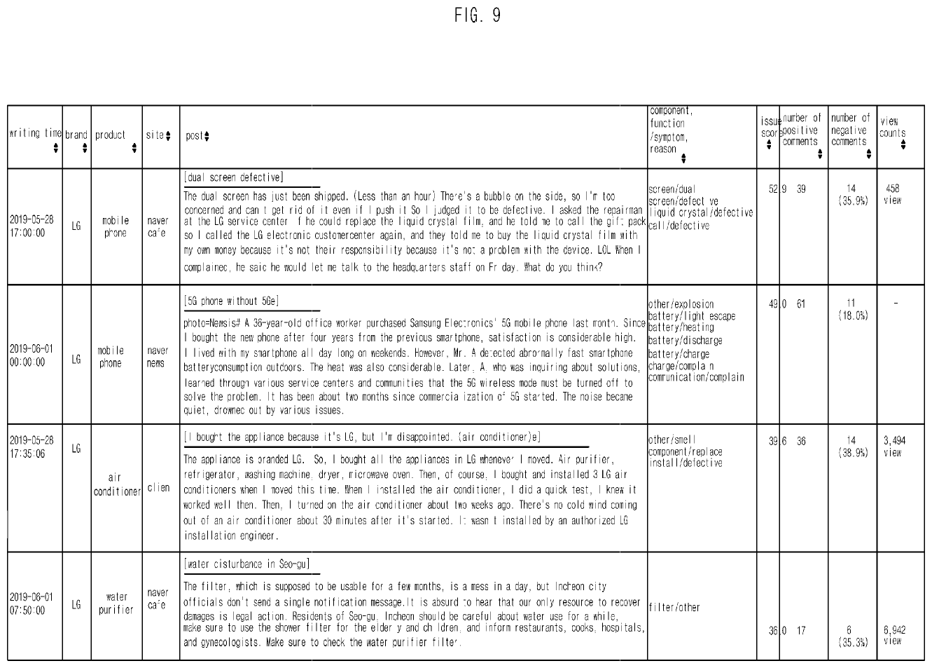

FIG. 8 is a diagram showing a screen 800 displaying an issue confirmed through monitoring. FIG. 9 is a diagram showing a screen 900 including a score of a confirmed issue.

First, in the screen 800 shown in FIG. 8, a plurality of confirmed issues may be arranged at a lower-left side, ranking of keywords may be arranged at a lower-central side, and an accumulated trend of keywords may be arranged at a lower-right side.

A plurality of issues, data, and the like related to ‘LG’ may be displayed in an upper portion of the screen 800.

Accordingly, a user may intuitively check issues confirmed through monitoring.

Then, as shown in FIG. 9, scores corresponding to a plurality of confirmed issues may be arranged on a right side in the screen 900.

Accordingly, a user may intuitively check issues confirmed through monitoring.

The aforementioned issue detection and monitoring scheme may be installed in various electronic devices in addition to the server 100, and may be continuously upgraded through learning.

A server according to an embodiment of the present disclosure may include a communicator for receiving and transmitting data from and to an external network and a processor for detecting and monitoring an online issue in an external network through the communicator, and the processor may collect text from a plurality of external servers, may perform learning on the collected text, may detect issues, and may monitor text corresponding to confirmed issues. Accordingly, an online issue in a network may be effectively detected and monitored.

The processor may perform issue scoring for calculating an issue score on a confirmed issue. Thereby, an online issue in a network may be effectively detected and scored.

The processor may collect text from a plurality of external servers during the first set period. Thus, text in a network may be effectively collected.

The processor may collect text from a plurality of external servers corresponding to a set related word during the first set period. Thus, text in a network may be effectively collected.

The processor may learn text that corresponds to the confirmed issue. Thus, an online issue in a network may be effectively detected and monitored.

The processor may perform learning and primary filtering on the collected text through a plurality of issue detection models and may perform secondary filtering on the collected text through a garbage-filtering model. Accordingly, an online issue in a network may be effectively detected and confirmed.

The processor may classify the collected text into formal text and informal text and may perform formal-text-based learning and informal-text-based learning on the collected text through a plurality of issue detection modules. Thus, an online issue in a network may be effectively detected and confirmed.

The processor may collect text related to the confirmed issue and may monitor the collected text that corresponds to the confirmed issue. Accordingly, an online issue in a network may be effectively detected and monitored.

The processor may perform issue scoring in proportion to at least one of a number of text entries corresponding to the confirmed issue, the speed at which the text is added, view counts of the text, recommendation of the text, or upvoting of the text during issue scoring. Accordingly, an online issue in a network may be effectively detected and monitored.

The processor may provide an issue confirmed through monitoring and an issue score therewith. Accordingly, issue-related information may be simply recognized.

The processor may include a data collector for collecting text from a plurality of external servers, a formal issue detector for learning the collected text and detecting a formal issue, an informal issue detector for learning the collected text and detecting an informal issue, and a monitoring device for monitoring text corresponding to the confirmed issue. Accordingly, an online issue in a network may be effectively detected and monitored.

The monitoring device may include an issue scorer for performing issue scoring for calculating an issue score on the confirmed issue. An online issue in a network may be effectively detected and scored.

The processor may further include a garbage filter for performing secondary filtering on results from the formal issue detector and the informal issue detector through a garbage-filtering model. Accordingly, an online issue in a network may be effectively detected and filtered.

A server according to another embodiment of the present disclosure may include a communicator for receiving and transmitting data from and to an external network, and a processor for detecting and monitoring an online issue in an external network through the communicator, and the processor may collect text from a plurality of external servers, and may perform issue scoring for calculating an issue score on the confirmed issue based on the collected text. Accordingly, an online issue in a network may be effectively detected and scored.

The processor may perform issue scoring in proportion to at least one of the amount of text corresponding to the confirmed issue, the speed at which the text is added, view counts of the text, recommendation of the text, or upvoting of the text during issue scoring. Accordingly, an online issue in a network may be effectively detected and scored.

The server according to the present specification is not limited to the configurations and methods of the above-described embodiments. That is, the above-described embodiments may be partially or wholly combined to realize various modifications.

While the present disclosure has been particularly shown and described with reference to exemplary embodiments thereof, it is clearly understood that the same is by way of illustration and example only and is not to be taken as limiting the present disclosure. It will be understood by those skilled in the art that various changes in form and details may be made therein without departing from the subject matter and scope of the present disclosure.

What is claimed is:

1. A server comprising:
a communicator to receive and transmit data from and to an external network; and
a processor to detect and monitor an online issue in the external network through the communicator,
wherein the processor collects text from a plurality of external servers, performs learning on the collected text, performs an issue detection, and monitors text corresponding to a confirmed issue.

2. The server of claim 1, wherein the processor performs issue scoring for calculating an issue score of the confirmed issue.

3. The server of claim 1, wherein the processor collects text from the plurality of external servers during a first set period.

4. The server of claim 1, wherein the processor collects text corresponding to a set related word from the plurality of external servers during a first set period.

5. The server of claim 1, wherein the processor performs learning on text corresponding to the confirmed issue.

6. The server of claim 1, wherein the processor performs learning and primary filtering on the collected text through a plurality of issue detection models and performs secondary filtering thereon through a garbage-filtering model.

7. The server of claim 1, wherein the processor classifies the collected text into formal text and informal text through a plurality of issue detection models and performs formal-text-based learning and informal-text-based learning.

8. The server of claim 1, wherein the processor collects text related to the confirmed issue and monitors text corresponding to the confirmed issue.

9. The server of claim 2, wherein the processor performs issue scoring in proportion to at least one of a number of text entries corresponding to the confirmed issue, a speed at which text is added, view counts of the text, recommendation of the text, or upvoting of the text during issue scoring.

10. The server of claim 1, wherein the processor provides an issue confirmed through monitoring and a score of the issue therewith.

11. The server of claim 1, wherein the processor comprises:
a data collector configured to collect text from a plurality of external servers;
a formal issue detector configured to perform learning on the collected text and to detect a formal issue;
an informal issue detector configured to perform learning on the collected text and to detect an informal issue; and
a monitoring device configured to monitor text corresponding to the confirmed issue.

12. The server of claim 11, wherein the monitoring device comprises a scorer configured to perform issue scoring for calculating an issue score on the confirmed issue.

13. The server of claim 11, wherein the processor further comprises a garbage filter configured to perform secondary filtering on results from the formal issue detector and the informal issue detector through a garbage-filtering model.

14. A server comprising:
a communicator to receive and transmit data from and to an external network; and
a processor to detect and monitor an online issue in the external network through the communicator,
wherein the processor collects text from a plurality of external servers, and performs issue scoring for calculating an issue score of a confirmed issue based on the collected text.

15. The server of claim 1, wherein the processor performs issue scoring in proportion to at least one of a number of text entries corresponding to the confirmed issue, a speed at which text is added, view counts of the text, recommendation of the text, or upvoting of the text during issue scoring.
